(19) United States
(12) Patent Application Publication
(10) Pub. No.: US 2026/0063557 A1
(43) Pub. Date: Mar. 5, 2026

(54) HALIDE MEASUREMENT WITH SILVER, 2,4,6-TRIPYRIDYL-S-TRIAZINE

(71) Applicant: Hach Company, Loveland, CO (US)

(72) Inventor: Devin Lee Maurer, Ankeny, IA (US)

(21) Appl. No.: 18/817,336

(22) Filed: Aug. 28, 2024

(51) Int. Cl. G01N 21/78; G01N 21/77

(52) U.S. Cl. CPC G01N 21/78; G01N 2021/7783

(57) ABSTRACT

An embodiment provides a method for measuring a halide in a sample, including: adjusting the pH of the sample with an amount of p-Toluenesolfonic acid (p-TSA); introducing silver 2, 4, 6-Tripyridyl-s-triazine (silver TPTZ) and an amount of iron (II) to the sample to make a reaction solution, wherein the sample comprises an amount of a halide; and measuring, using a color method, the amount of the halide in the sample by measuring an intensity of the absorbance of the reaction solution. Other aspects are described and claimed.

### BACKGROUND

This application relates generally to measuring halides in a sample, and, more particularly, to measuring a halide in the presence of a silver, 2, 4, 6-Tripyridyl-s-triazine (TPTZ).

Ensuring water quality is critical in a number of industries such as pharmaceuticals and other manufacturing fields. Additionally, ensuring water quality is critical to the health and well-being of humans, animals, and plants which are reliant on the water for survival. Analytes such as halides may be measured and monitored. Halides level outside of acceptable parameters in water can be harmful to humans or animals, or interfere with proper disinfection or treatment of water. For example, halides may cause the water to be less desirable to consumers or facilities. Halides may be present from natural or human activities such as manufacturing. Measurement and mitigation of halides may result in higher costs of water treatment. Therefore, detecting the presence and concentration of halides in water or other liquid solutions is vital.

### BRIEF SUMMARY

In summary, one embodiment provides a method for measuring a halide in a sample, comprising: adjusting the pH of the sample with an amount of p-Toluenesolfonic acid (p-TSA); introducing silver 2, 4, 6-Tripyridyl-s-triazine (silver TPTZ) and an amount of iron (II) to the sample to make a reaction solution, wherein the sample comprises an amount of a halide; and measuring, using a color method, the amount of the halide in the sample by measuring an intensity of the absorbance of the reaction solution.

Another embodiment provides a measurement device for measuring a halide in a sample, comprising: a measurement chamber; a sensor to detect a colorimetric change; a processor; and a memory storing instructions executable by the processor to: adjust the pH of the sample with an amount of p-Toluenesolfonic acid (p-TSA); introduce, into the measurement chamber, silver 2, 4, 6-Tripyridyl-s-triazine (silver TPTZ) and an amount of iron (II) to the sample to make a reaction solution, wherein the sample comprises an amount of a halide; and measure, using the sensor, the amount of the halide in the sample by measuring an intensity of the absorbance of the reaction solution.

A further embodiment provides a product for measuring a halide in a sample, comprising: a computer-readable storage device that stores executable code that, when executed by a processor, causes the product to: code that adjusts the pH of the sample with an amount of p-Toluenesolfonic acid (p-TSA); code that introduces, into the measurement chamber, silver 2, 4, 6-Tripyridyl-s-triazine (silver TPTZ) and an amount of iron (II) to a sample to make a reaction solution, wherein the sample comprises an amount of a halide; and code that measures, using the sensor, using a color method, the amount of the halide in the sample by measuring an intensity of the absorbance of the reaction solution.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates and chemical reaction using silver in combination with TPTZ and iron (II) to measure chloride.

FIG. 2 illustrates a flow diagram of an example halide measurement method.

FIG. 3A illustrates a Hach® mercuric thiocyanate method to measure chloride.

FIG. 3B illustrates a Hach® QuanTab method to measure chloride.

FIG. 3C illustrates a Hach® silver chloride turbidity method to measure chloride.

FIG. 3D illustrates a Hach® silver nitrate dichromate method to measure chloride.

FIG. 4A illustrates a Hach® mercuric nitrate dipenylcarbazone method to measure chloride.

FIG. 4B illustrates a mercuric mercuric TPTZ ferrous method to measure chloride.

FIG. 5 illustrates example data of the accuracy of using silver in combination with TPTZ and iron (II) to measure chloride.

FIG. 6 illustrates example data of using silver in combination with TPTZ and iron (II) to measure different halides.

FIG. 7 illustrates an example of computer circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Halide measurement in water or other aqueous samples or solutions is important for many different reasons. Halides may include, but are not limited to chloride, bromide, iodide, or the like. For ease of reading, halides or specifically chloride may be used as an example. For example, measurement may be used to determine the quality of water. High concentrations may be harmful to animals, humans, and/or plants. Accordingly, as another example, a user or entity may want the halide in a body of water to be under a particular threshold, therefore, the user may measure the halide in order to determine if the amount of halide is under that threshold. Halides may be present in a body of water either naturally or from human activity such as manufacturing or storage conditions. Also, a level of halides may need to be monitored and/or controlled in a solution for human consumption, medical, industrial, food/beverage, or manufacturing applications. As another example, a halide may be introduced into a sample for disinfection or preparation of a volume of water for human consumption, food manufacturing, pharmaceutical manufacture, or the like.

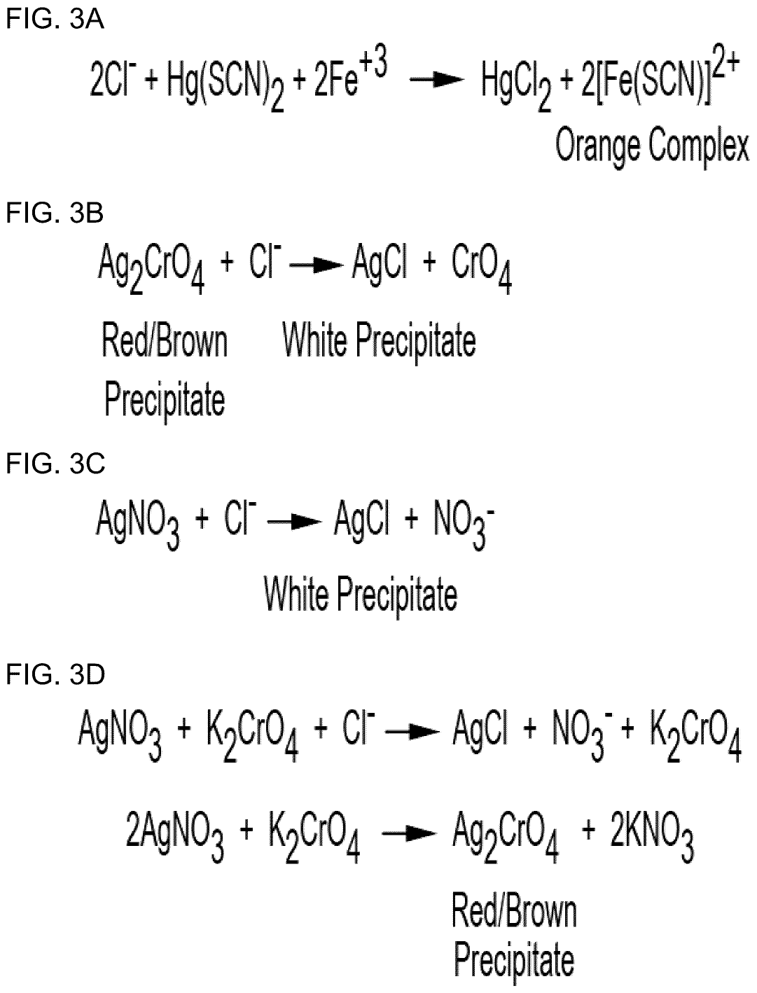

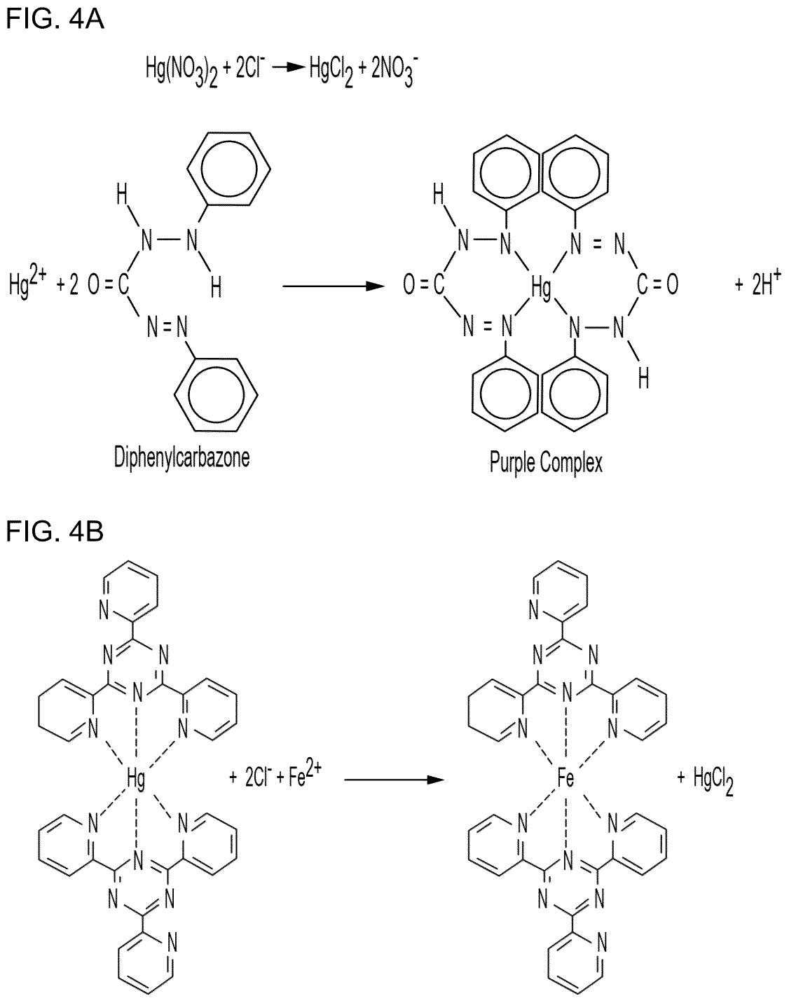

Conventional methods of chloride and halide measurement and detection may have limitations discussed herein. For example, conventional methods may use mercury, dichromate, and/or thiocyanate. Governments may have limits of use or waste disposal requirements for this conventional method. Such reagents pose a hazard to both a user and remain a costly step to properly dispose of the reagents. Various methods using these harmful reagents are illustrated in FIG. 3 and FIG. 4. Such examples include mercuric thiocyanate (FIG. 3A), QuanTab (FIG. 3B), silver chloride turbidity (FIG. 3C), silver nitrate dichromate (FIG. 3D), mercuric nitrate diphenylcarbazone (FIG. 4A), and mercuric TPTZ ferrous (FIG. 4B) available from Hach Company, Loveland CO, USA (HACH is a registered trademark of Hach Company in the United States and other countries).

However, there are some limitations with these methods. Mainly, the methods use mercury, dichromate, and/or thiocyanate. At the very least, such reagents may cause irritation of the skin, eyes, nose, and throat. The reagents are also known carcinogenic substances. Therefore, the reduction or complete elimination of the use of these reagents is beneficial to users of a product, and reduces cost, storage, and disposal of entities using the product. Current methods, systems, and kits for chloride measurement using the above method involve hazardous or controlled reagents make obtaining the reagents and disposal difficult. What is needed is an accurate method to measure chloride in a sample with less hazardous reagents.

Accordingly, an embodiment provides a system and method for measuring halides using silver, 2, 4, 6-Tripyridyl-s-triazine (TPTZ). In an embodiment, Iron (II) is added to the reaction. In an embodiment the halide may be chloride, bromide, iodide, or the like. In an embodiment, hazardous reagents such as mercury, dichromate, and/or thiocyanate are not used. In an embodiment, a colorimetric method or color method may be used to measure a halide or an amount of halide in an aqueous sample or solution. The aqueous sample may contain an amount of halide to be measured. In an embodiment, the amount of halide in an aqueous sample may be measured by measuring a change in intensity of the absorbance in the presence of silver TPTZ and Iron (II). In an embodiment, change in intensity of the absorbance is proportional to a concentration of the amount of halide in the aqueous sample. In an embodiment, the reaction or indicator reagents may be introduced to the aqueous sample in a form selected from the group consisting of: a solution, a powder, and a prepackaged module. In an embodiment, the aqueous sample may be a sample of water for quality testing. The system and method may use colorimetric, spectrophotometric, color wheel, or the like for measurement.

The illustrated example embodiments will be best understood by reference to the figures. The following description is intended only by way of example, and simply illustrates certain example embodiments.

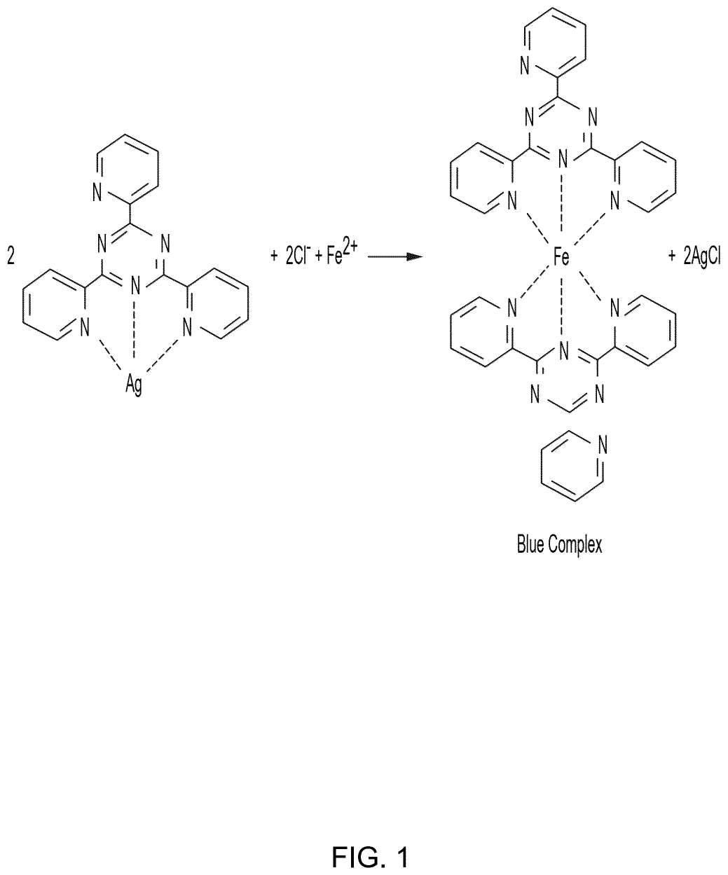

Referring to FIG. 1, in an embodiment, a reaction schematic is illustrated using silver, 2, 4, 6-Tripyridyl-s-triazine (TPTZ) for the detection and measurement of chloride. In addition to chloride, other halides may be measured. Iron (II) is added to the reaction. The silver in combination with TPTZ and Iron (II) to determine chloride with a colorimetric test or method that could be utilized at the bench or in the field without the use of hazardous chemical such as mercury, thiocyanate, or dichromate as used in other chloride tests.

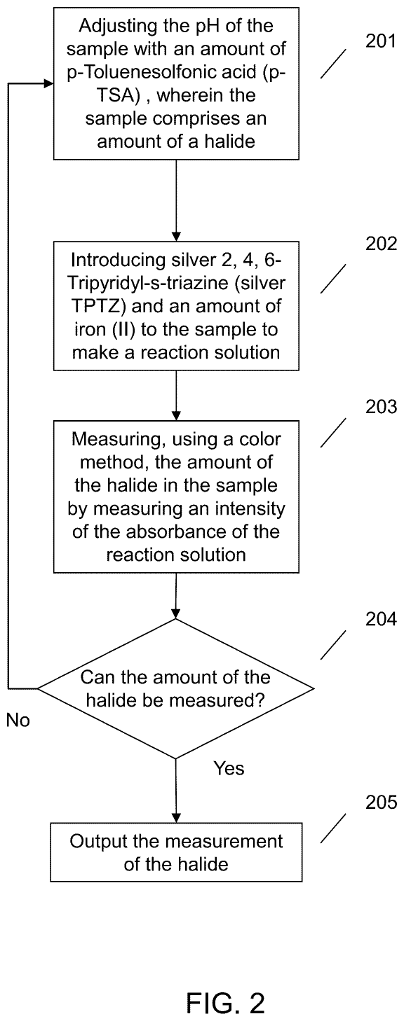

Referring to FIG. 2, in an embodiment, an example system and method for measurement of chloride in a sample or an aqueous sample or solution is illustrated. Different concentrations of a halide, or specifically chloride, may result in different colorimetric intensities, the change in the colorimetric intensity may be correlated to a concentration of halide or chloride in the sample.

Referring to FIG. 2. at 201, in an embodiment, p-Toluenesulfonic acid (p-TSA) may be added to the aqueous sample or sample. At 202, silver, 2, 4, 6-Tripyridyl-s-triazine (silver TPTZ) and iron (II) may be added to the sample with the p-Toluenesulfonic acid (p-TSA) which may be referred to as the pH adjusted sample solution. In an embodiment, the p-TSA may acidify or adjust a pH of the sample solution. In an embodiment, a reagent set of silver, TPTZ and iron (II) may be used to colorimetrically measure chloride in water samples. In an embodiment, the sample with the iron (II) and TPTZ may be referred to as a reaction solution silver may be complexed with TPTZ resulting in a yellow color. In an embodiment, once chloride or halide is introduced, or already present in a sample, the chloride or halide will react with the silver and precipitate out allowing, the now free TPTZ may react with iron (II) forming a blue complex. The blue complex may be in proportion to the concentration of the chloride or halide in the sample. This color change could be measured using color wheel, colorimeter, or spectrophotometer which may be referred to as a color or colorimetric method.

In an embodiment, a sample or aqueous sample may be prepared. Reagents for the indicator, buffer, iron, or measurement may be placed in a solution, aqueous sample, water sample or the like. The sample may be added, with other components, to a chamber, vessel, or the like as a powder, a liquid, or a prepackaged module. The sample and/or components may be added manually or using an autonomous system. In other words, the reagents for the method may be prepackaged and/or premeasured for ease of use. The prepackaged reagents may be added to a sample, or the sample may be added to a prepackaged reagent container or vial. Therefore, the silver, TPTZ, buffer and iron may be in prepackaged modules or a plurality of prepackaged modules for combination with a sample with the halide to be measured.

In an embodiment, the aqueous sample may be buffered or adjusted to a pH value. In an embodiment, a pH value may be selected to minimize interferences. For example, a pH may be selected based upon the concentration and/or composition of interferences. In an embodiment, the sample or reaction solution may be pH adjusted to 1.5-2.0 using p-Toluenesulfonic acid (p-TSA). The p-TSA, like any reagent, may be added by hand, gravity fed, or pumped using associated valves, tubing, or the like. The addition of reagents may be controlled by a system or product as described herein.

The aqueous sample may include a sample from a natural body of water, a holding tank, a processing tank, a pipe, industrial effluent, wastewater, or the like. The solution may be in a continuous flow, a standing volume of liquid, or any combination thereof. In one embodiment, the solution may be introduced to a reducing agent or a buffer, for example, a test chamber of the measurement device. In an embodiment, the measurement device may be a benchtop, field, or hand-held device. A hand-held device may have advantages such as lower cost, portability, field use, or the like. Introduction of the solution into the measurement device may include placing or introducing the solution into a test chamber manually by a user or using a mechanical means, for example, gravity flow, a pump, pressure, fluid flow, or the like. For example, a water sample for halide measurement may be introduced to a measurement or test chamber using a pump. In an embodiment, valves or the like may control the influx and efflux of the solution into or out of the one or more chambers, if present.

A chamber, vessel, cell, chamber, or the like may contain an aqueous sample and associated reagents. Various reagents may be added to an aqueous sample in the form of a powder, a liquid, a prepackaged module, or the like. A device may contain one or more bottles of reagents which contain necessary reagents. The reagents contained in the one or more bottles may be pump fed or gravity fed. The flow of the reagents may be metered to ensure proper volume delivery to the measurement cell. The aqueous sample may be fed through a pressured inlet, a vessel, or the like. The aqueous sample may be introduced into the measurement chamber by a pump or gravity fed. The sampling device may be in series or parallel to an aqueous flow. The device may have a system to ensure proper mixing of the aqueous sample with a reagent. The method or device may have a heating element to heat a sample and/or reagents.

Additionally or alternatively, the measurement device may be present or introduced in a volume of the solution. The measurement device may then be exposed to the volume of an aqueous sample where it may perform measurements. The system may be a flow-through system in which an aqueous sample and/or reagents are automatically mixed and measured. Once the sample is in contact with the measurement system, the system may measure the halide or an amount of halide of the sample, as discussed in further detail herein. In an embodiment, the measurement device may include one or more chambers in which the one or more method steps may be performed.

In an embodiment, a sample with halide to be measured may be a predetermined volume or brought to a predetermined volume with deionized water. Reagents described herein may be added to this volume. There may be more than one reagent added at different points in the measurement process. In other words, a first reagent may be added, the sample mixed, then a second reagent added, and then mixed once again. Mixing may be accomplished by mechanical inversion, stirring, pumping, or the like. Mixing may be performed at intermediate steps in between the addition of different reagents.

At 203, in an embodiment, an amount of halide such as chloride may be measured using a color or colorimetric method. The halide may be present in the reaction solution. In an embodiment, the presence of halide in an aqueous solution may cause an increase in absorbance intensity. Thus, the change in absorbance of the solution may be proportional to the amount of halide within the solution or sample. Accordingly, a measurement device or user can correlate the measured change in absorbance with the amount of halide in the aqueous sample. In an embodiment, colorimetric techniques may measure a concentration of the halide.

The color method may be a colorimeter, a spectrophotometer, a color wheel, or the like. For example, A colorimeter measures the absorbance at a wavelength of light through a sample in a sample cuvette or vial. A colorimeter determines the concentration of a component in a liquid sample within a sample cuvette by projecting a light beam into the liquid sample within the cuvette. An absorbance for the given wavelength may then be measured. A concentration of the component of the sample may be measured as proportional to the absorbance. Different wavelengths may be selected based upon the species to be measured and specific applications. A colorimeter may pass a light source through an aperture to a lens and/or a color filter. The wavelength of light may be selected for a given application. The light may then pass through a cuvette or sample cell/chamber. After passing through a cuvette the light may strike a photocell for a measurement of absorbance in the form of an output. The absorbance may be correlated to a concentration of the species to be measured in a sample.

As another, he resulting color from the colorimetric reaction may be determined photometrically, for example, using a spectrophotometer. The spectrometer may comprise a light source, a collimator, a monochromator, a wavelength selector, a cuvette for sample solution, a photoelectric detector, and a digital display or a meter. A spectrophotometer may quantitatively compare a fraction of light that passes through a reference solution and a sample, and compares the intensities of the two signals and determines the percentage of transmission of the sample compared to the reference standard.

As a further example, the measurement may be made using a color wheel. A color wheel is a simple and field usable device in which a set of colors to a known standard are presented to a user. The user may then determine which color on the color wheel resulting from the colorimetric reaction correlates with the resulting reaction color.

For example, the measuring may be a measurement of an absorbance at a wavelength for a colored complex. The measuring may include taking a ratio of absorbance collected at multiple wavelengths. Different measurement devices may be used to perform the measurement, for example, a portable parallel analyzer (PPA, such as the SL1000 available from Hach Company, Loveland, CO), test strips, colorimetric analyzers, spectrophotometers, pocket colorimeters, online process instruments, color wheels, and the like.

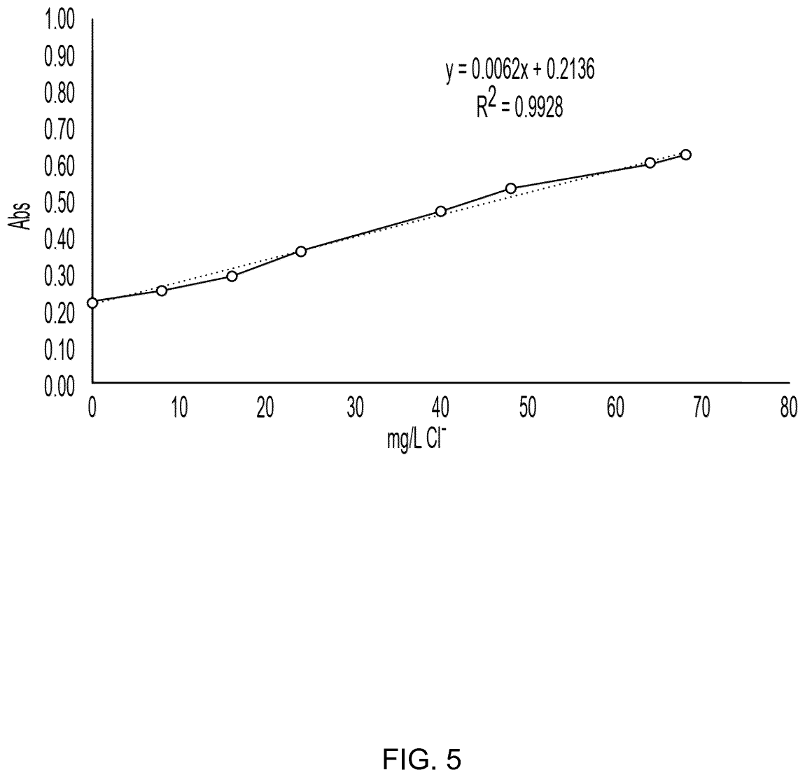

Therefore, the absorbance intensity, of an aqueous sample containing halide may be correlated to the concentration of the halide in the aqueous solution. In an embodiment, the amount of absorbance may be proportional to an amount or concentration of halide in the solution. Absorbance curves may be generated for a range of halide concentrations, for any different condition that may affect absorption or absorbance values (e.g., temperature, sample content, turbidity, viscosity, measurement apparatus, aqueous sample chamber, etc.), or the like. The absorbance curves can then be used for determining the amount of halide in the solution. Referring to FIG. 5, in an embodiment, some example data of chloride measurement of 25 mL samples in a 1 inch cell, measured at 590 nm following a 1 minute hold time using silver TPTZ and iron (II) is illustrated. The method shows accuracy over the concentration range indicated, for example 0-70 milligrams/liter (mg/L) of chloride.

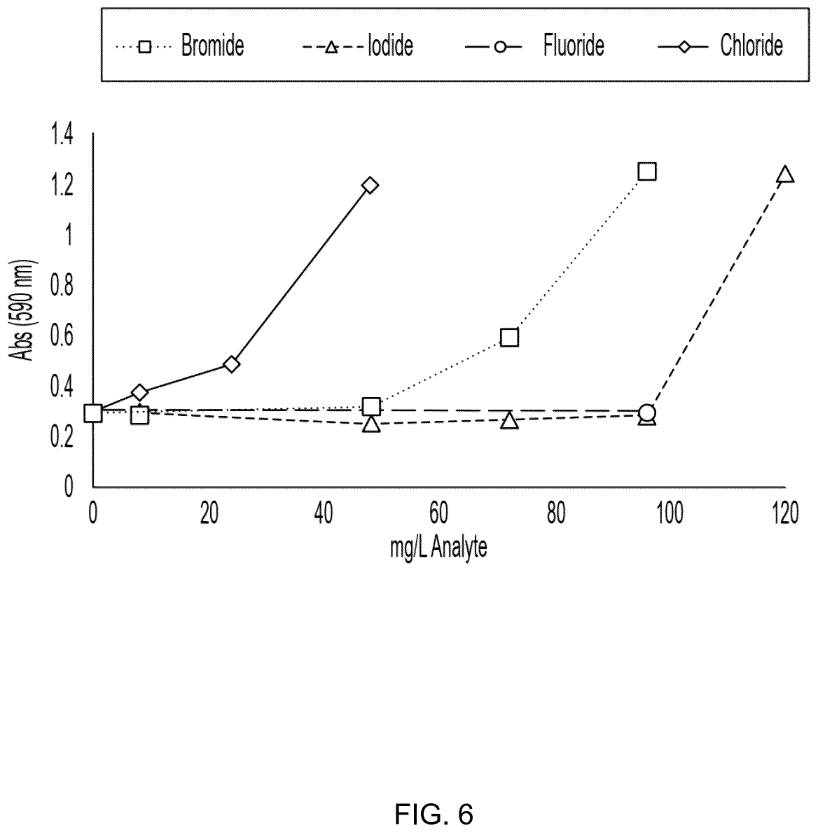

Referring to FIG. 6, in an embodiment, example data are illustrated using silver TPTZ with iron (II) in the measurement of halides. Silver fluoride is soluble in water and would not allow this approach to work for its detection. The silver fluoride would need to be insoluble so that silver would be removed from the solution allowing the Iron (II) to react with the TPTZ. Metals that do form insoluble salts with fluoride, calcium, and magnesium, were also tested in place of silver. These metals were proven to not form a strong enough complex with the TPTZ to keep the Iron from complexing without the presence of fluoride. Bromide and iodide result in a colorimetric response similar to the chloride response, but may be less sensitive due to order of atomic weight. Nitrite and sulfite were also tested with no colorimetric results over the range tested.

At 204, in an embodiment, the system and method may determine if an amount of halide may be measured. For example, an amount of halide may be measured using colorimetric methods using a spectrophotometer, colorimeter, color wheel, or the like. The absorbance measurements may be compared to expected values, historical values, or the like. Halide measurement using spectrophometric methods may be at periodic intervals set by the user or preprogrammed frequencies in the device. Measurement of halide by a device allows for real time data with very little human involvement in the measurement process. In the event that the system outputs an unexpected value, the system may automatically request re-measurement of a solution or sample.

A programmed calibration curve may be entered into the device for calibrating the measurement device. In an embodiment, the system and method may be periodically tested using a known amount of halide in the sample. The system may then recalibrate or send an error report for maintenance. In the event that the error is caused by an unclean device or that the device otherwise needs cleaned, the system may implement a cleaning cycle. Cleaning of the spectrophotometer or measurement chamber may be required at an unspecified time interval, after a certain number of measurements, upon user or system request, or the like. In an embodiment, a cleaning cycle of the measurement device may be performed using either automated or manual methods.

At 204, in an embodiment, if a concentration of halide cannot be determined, the system may continue to measure halide and/or an absorbance signal. Additionally or alternatively, the system may output an alarm, log an event, or the like. If a concentration of halide can be determined, the system may provide a measurement of halide concentration at 205. The measurement which may be the absorbance intensity or halide concentration may be an output that is provided to a device in the form of a display, printing, storage, audio, haptic feedback, or the like. Alternatively or additionally, the output may be sent to another device through wired, wireless, fiber optic, Bluetooth®, near field communication, or the like.

An embodiment may use an alarm to warn of a measurement or concentration outside acceptable levels. An embodiment may use a system to shut down water output or shunt water from sources with unacceptable levels of halide. For example, a halide measuring device may use a relay coupled to an electrically actuated valve, or the like. The system may connect to a communication network. The system may alert a user or a network. This alert may occur whether a halide measurement is determined or not. An alert may be in a form of audio, visual, data, storing the data to a memory device, sending the output through a connected or wireless system, printing the output or the like. The system may log information such as the measurement location, a corrective action, geographical location, time, date, number of measurement cycles, or the like. The alert or log may be automated, meaning the system may automatically output whether a correction was required or not. The system may also have associated alarms, limits, or predetermined thresholds. For example, if a halide concentration reaches a threshold. Alarms or logs may be analyzed in real-time, stored for later use, or any combination thereof.

Absorbance may be measured using different methods. For example, the measurement may be made in a vial or cuvette. As another example, the absorbance measurement may be performed using a micro or mesofluidic device, such as a “lab on a chip”type device. Example absorbance data on a mesofluidic prepackaged module. Accordingly, a measurement device or user can correlate the measured change in absorbance with the amount of halide in the aqueous sample.

The various embodiments described herein thus represent a technical improvement to conventional halide measurement techniques. Using the techniques as described herein, an embodiment may use an indicator to measure halide in solution using a method safer for users and more environmentally safe. This is in contrast to the use of dangerous reagents with limitations mentioned above. Such techniques provide a faster and more accurate method for measuring halide in an aqueous or liquid solution, while using less dangerous or harmful chemicals or reagents in halide measurement.

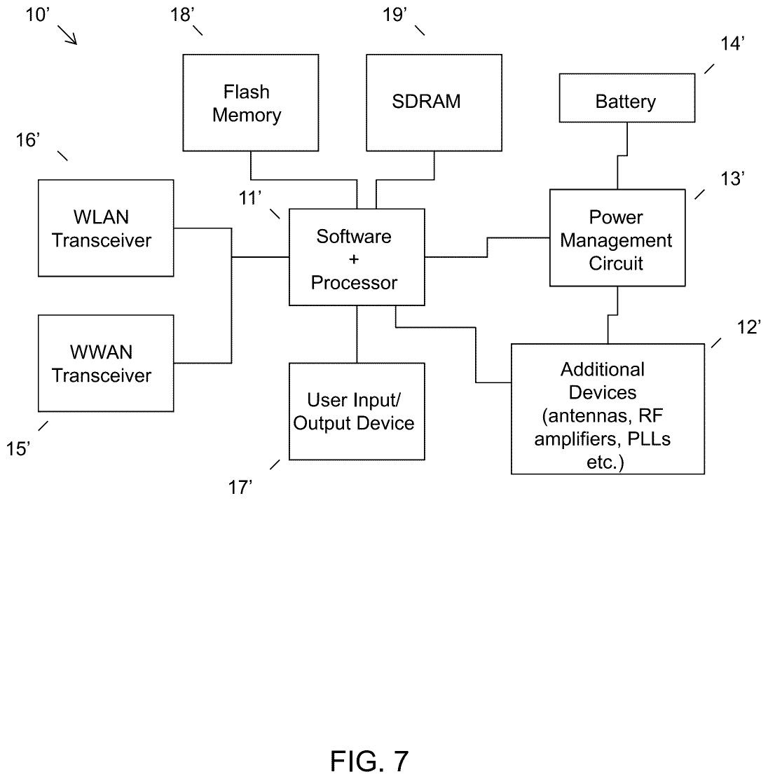

While various other circuits, circuitry or components may be utilized in information handling devices, regarding an instrument for measurement of halides according to any one of the various embodiments described herein, an example is illustrated in FIG. 7. Device circuitry 10′ may include a measurement system on a chip design found, for example, a particular computing platform (e.g., mobile computing, desktop computing, etc.) Software and processor(s) are combined in a single chip 11′. Processors comprise internal arithmetic units, registers, cache memory, busses, I/O ports, etc., as is well known in the art. Internal busses and the like depend on different vendors, but essentially all the peripheral devices (12′) may attach to a single chip 11′. The circuitry 10′ combines the processor, memory control, and I/O controller hub all into a single chip 11′. Also, systems 10′ of this type do not typically use SATA or PCI or LPC. Common interfaces, for example, include SDIO and I2C.

There are power management chip(s) 13′, e.g., a battery management unit, BMU, which manage power as supplied, for example, via a rechargeable battery 14′, which may be recharged by a connection to a power source (not shown). In at least one design, a single chip, such as 11′, is used to supply BIOS like functionality and DRAM memory.

System 10′ typically includes one or more of a WWAN transceiver 15′ and a WLAN transceiver 16′ for connecting to various networks, such as telecommunications networks and wireless Internet devices, e.g., access points. Additionally, devices 12′ are commonly included, e.g., a transmit and receive antenna, oscillators, PLLs, etc. System 10′ includes input/output devices 17′ for data input and display/rendering (e.g., a computing location located away from the single beam system that is easily accessible by a user). System 10′ also typically includes various memory devices, for example flash memory 18′ and SDRAM 19′.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to perform measurement of halides of an aqueous sample or a sample.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system. ” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a hand held measurement device, or other programmable data processing device to produce a machine, such that the instructions, which execute via a processor of the device, implement the functions/acts specified.

It is noted that the values provided herein are to be construed to include equivalent values as indicated by use of the term “about. ” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for measuring a halide in a sample, comprising:
adjusting the pH of the sample with an amount of p-Toluenesolfonic acid (p-TSA);
introducing silver 2, 4, 6-Tripyridyl-s-triazine (silver TPTZ) and an amount of iron (II) to the sample to make a reaction solution, wherein the sample comprises an amount of a halide; and
measuring, using a color method, the amount of the halide in the sample by measuring an intensity of the absorbance of the reaction solution.

2. The method of claim 1, wherein the amount of the halide comprises chloride.

3. The method of claim 1, wherein the amount of the halide comprises bromide.

4. The method of claim 1, wherein the amount of the halide comprises iodide.

5. The method of claim 1, wherein the change in intensity of the absorbance is proportional to a concentration of the amount of the halide in the sample.

6. The method of claim 1, wherein the color method comprises a colorimeter.

7. The method of claim 1, wherein the color method comprises a spectrophotometer.

8. The method of claim 1, wherein a concentration of the silver TPTZ is adjusted based upon the amount of the halide.

9. The method of claim 1, wherein the p-Toluenesolfonic acid (p-TSA) acidifies the reaction solution to a pH range of about 1.5 to 2.0.

10. The method of claim 1, further comprising mixing the sample, silver TPTZ, and the amount of iron (II).

11. A measurement device for measuring a halide in a sample, comprising:
a measurement chamber;
a sensor to detect a colorimetric change;
a processor; and
a memory storing instructions executable by the processor to:
adjust the pH of the sample with an amount of p-Toluenesolfonic acid (p-TSA);
introduce, into the measurement chamber, silver 2, 4, 6-Tripyridyl-s-triazine (silver TPTZ) and an amount of iron (II) to the sample to make a reaction solution, wherein the sample comprises an amount of a halide; and
measure, using the sensor, the amount of the halide in the sample by measuring an intensity of the absorbance of the reaction solution.

12. The device of claim 11, wherein the amount of the halide comprises chloride.

13. The device of claim 11, wherein the amount of the halide comprises bromide.

14. The device of claim 11, wherein the amount of the halide comprises iodide.

15. The device of claim 11, wherein the change in intensity of the absorbance is proportional to a concentration of the amount of the halide in the sample.

16. The device of claim 11, wherein the color method comprises a colorimeter.

17. The device of claim 11, wherein the color method comprises a spectrophotometer.

18. The device of claim 11, wherein a concentration of the silver TPTZ is adjusted based upon the amount of the halide.

19. The device of claim 11, wherein the p-Toluenesolfonic acid (p-TSA) acidifies the reaction solution to a pH range of about 1.5 to 2.0.

20. A product for measuring a halide in a sample, comprising:
a computer-readable storage device that stores executable code that, when executed by a processor, causes the product to:
code that adjusts the pH of the sample with an amount of p-Toluenesolfonic acid (p-TSA);
code that introduces, into the measurement chamber, silver 2, 4, 6-Tripyridyl-s-triazine (silver TPTZ) and an amount of iron (II) to a sample to make a reaction solution, wherein the sample comprises an amount of a halide; and
code that measures, using the sensor, using a color method, the amount of the halide in the sample by measuring an intensity of the absorbance of the reaction solution.
